(19) United States
(12) Patent Application Publication
(10) Pub. No.: US 2018/0021710 A1
(43) Pub. Date: Jan. 25, 2018

(54) FILTER MEDIUM AND FILTERS MADE THEREFROM

(71) Applicant: GP Cellulose GmbH, Zug (CH)

(72) Inventors: Arthur J. NONNI, Peachtree City, GA (US); Charles E. COURCHENE, Snellville, GA (US); Christopher M. SLONE, Atlanta, GA (US)

(73) Assignee: GP Cellulose GmbH, Zug (CH)

(21) Appl. No.: 15/549,841

(22) PCT Filed: Feb. 9, 2016
(86) PCT No.: PCT/US2016/017217

§ 371 Date: Aug. 9, 2017

Related U.S. Application Data
(60) Provisional application No. 62/114,481, filed on Feb. 10, 2015.

(51) Int. Cl. B01D 39/18; F24F 3/16; B01D 46/52; B01D 46/00; B01D 39/16; B01D 39/20

(52) U.S. Cl. CPC B01D 39/18; B01D 39/1623; B01D 39/2017; B01D 46/521; B01D 46/0028; F24F 3/1603; B01D 2239/0442; B01D 2279/50; F24F 2003/1614

(57) ABSTRACT

A filter media including an oxidized cellulose kraft fiber is described. The filter media provides improved filter characteristics including anti-microbial properties and anti-odor characteristics. The filter media may be used in both air filters and water filter.

A fibrous filter medium is provided which includes an oxidized kraft cellulose fiber. More specifically, a filter media is provided that exhibits improved filter performance.

Filters, including high performance filters are commonly used in commercial and residential markets. Filter media can be used to remove contamination in a variety of applications. Depending on the application, filter media are designed to have different performance characteristics. Filter media are commonly formed of a non-woven web of fibers, and performance characteristics are manipulated by changing the properties of the non-woven web, including, for example, the composition of the fibers, the size of the fibers, the spacing of the fibers, and fiber additives or coatings. Non-woven webs are generally the filter media of choice when large quantities of particulate loading, long life or general clarification of a liquid or gas stream is required.

The fiber web provides a porous structure that permits fluid (e.g., gas, air, water) to flow through the filter media. Contaminant particles within the fluid are trapped on the fibrous web. Filter media characteristics, such as pressure drop, surface area, and basis weight, affect filter performance, including filter efficiency and resistance to fluid flow through the filter. In general, higher filter efficiencies result in a higher resistance to fluid flow, which leads to higher pressure drops for a given flow rate across the filter and increased energy consumption. Current commercial filters typically comprise synthetic materials including for example, polyester, polypropylene, and fiberglass. Such filters occasionally contain natural fiber, such as cotton.

Filters find use in a variety of air handling applications including, but not limited to, ventilation systems, industrial air handlers, clean rooms, HVAC, respiratory protection, and industrial processes, for example automobile assembly. Filters find use in a variety of liquid handling applications including, but not limited to, disposable water filters, residential water purification filters, industrial water purification filters, including water filtration in HVAC applications, petrochemical applications, pulp and paper applications, drinking water, metal processing applications, waste water applications, food industry applications and plastics production applications.

High quality synthetic air filters are often expensive as the raw materials for producing these filters are expensive. High efficiency particulate air (HEPA) filters are well known in the art to be among the cleanest air filters on the market with efficiencies up to the 99.9% in the 0.3 micron particle range. HEPA filters generally include high density media packs of filtration media. The large contact area of the HEPA filter media improves their filter efficiency. HEPA filters not only act like a sieve where particles larger than the largest opening cannot pass through, but HEPA filters are also designed to target much smaller pollutants and particles. Smaller particles are trapped via interception, i.e., where a particle follows a line of flow in the air stream coming into close proximity to a fiber and adhering to it; via inertial impaction, where larger particles are unable to avoid fibers by following the curving contours of the air stream and are forced to embed in one of them directly; and via diffusion. Heretofore, HEPA filters have been designed to arrest very fine particles effectively, but they do not filter out gasses and odor molecules.

Disposable HVAC filters are among the most commonly recognized air filters and are often pleated filters contained within a cardboard frame. The filter medium is often a fiberglass or polyester media that is pleated to improve the surface area of the filter and minimize the pressure drop across the filter while removing many of the contaminants associated with indoor air quality. Disposable air filters are intended to be changed regularly and are not generally treated with antimicrobial compositions which are expensive and have therefore most often incorporated into permanent filters.

For applications in heating, ventilating, refrigerating, and air conditioning applications, the media can be designed to have performance characteristics approved by the American Society of Heating, Refrigeration and Air Conditioning Engineers (ASHRAE). Such media are referred to as ASHRAE filter media. ASHRAE filters, like other commercial air filters, as described above, are produced predominately of expensive synthetic fiber materials. The filter media as described herein provides a low cost substitute for synthetic materials while maintaining commercially acceptable filter efficiencies, improving odor control and minimizing microbial growth.

Filters also find use in a variety of water purification and liquid separation processes. Water filters take many forms depending upon the product or process in which the filter will be used. For example, consumers are familiar with water filters that fit in a water bottle, attach to a sink, or fit in a water line to a refrigerator. Larger water filters for residential use include spa or pool filters. Other less familiar liquid purification filters include bag filters that may be attached to a pipe outlet to strain, for example, water, milk, paint or other chemical products.

There remains a need for low cost, highly effective filter media that provides commercially appropriate fluid filtration while providing improved anti-microbial properties without the need for expensive additives. There also remains a need for low cost, highly effective filter media that provides commercially appropriate air filtration while providing improved odor reduction without the need for additives.

As described herein, a filter media is comprised of randomly arranged fibers including oxidized kraft cellulose fiber, and in some instances, a combination of oxidized kraft cellulose fibers and synthetic fibers. The oxidized kraft cellulose fiber provides a low cost alternative to the synthetic fiber raw material and also improves the anti-microbial qualities of the air or water filter without comprising filtration efficiency.

There is further described herein an air filter comprising a physical frame enclosing a filter media comprising a substrate of randomly arranged fibers including synthetic fiber and oxidized kraft cellulose fiber. More particularly, the air filter provides odor filtration.

Finally, there is described a method of filtering air or water by passing the air or water through a filter media that including both synthetic fiber and oxidized kraft cellulose fiber.

### DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same assembly or component by different names. This document does not intend to distinguish between components or features that differ in name but not structure or function.

In the following discussion and in the claims, the terms “including” and “comprising” are used in an open-ended fashion, and thus should be interpreted to mean “including, but not limited to . . . The use of “top,” “bottom,” “above,” “below,” and variations of these terms is made for convenience, but does not require any particular orientation of the components.

The fluid filter media as described comprises an oxidized cellulose kraft fiber. As used herein the term “fluid” refers to both liquids and gases. Kraft fiber is often a less expensive alternative to other regenerated cellulose materials or synthetic materials. Oxidized kraft cellulose fiber can be produced using the oxidation processes as described in U.S. Pat. No. 8,778,136, published U.S. Applications US 20120175073, US2014/0274680, US 2014/0371442, and US 2014/0318725 and published international applications WO2014/140852, WO2014/140940 and WO2014/122533, all of which are incorporated by reference herein in their entirety. The oxidation methods as described in these applications and patent provide the appropriate fiber characteristics and chemical functionality to result in filter media products that have anti-microbial/anti-viral characteristics, anti-odor characteristics, and an improved cost profile.

When the oxidized cellulose kraft fiber is used as a filtration media without the addition of synthetic fibers, it exhibits commercially acceptable filtration at a fraction of the cost. In addition, the ability of these oxidized fibers to inhibit bacterial and viral growth result in a fiber media that has advantages over other similar filtration media. The oxidized cellulose kraft fiber media as described exhibits antimicrobial properties, including resistance to E-coli, Staphylococcus aureus, Alamonella enterica pullorum, and Listeria monocytogenes. The oxidized fiber media has also shown anti-viral properties when tested with Rhinovirus and Influenza.

The functionality associated with the oxidized fiber not only improves the anti-microbial/anti-viral properties of the filter media but further improves the bonding of fiber to the synthetic fiber when the oxidized fiber is used in combination with a synthetic fiber. According to one embodiment, the filter further comprises a synthetic fiber. The synthetic fiber may be any art recognized synthetic fiber material including, but not limited to, fiberglass, polyethylene, polyester, polypropylene, acrylic, rayon, nylon, fluoropolymers and the like, as well as combinations thereof. The synthetic fiber may be a bicomponent fiber, for example, a core and sheath fiber where the synthetic material in the core portion differs from the synthetic material in the sheath portion.

Filter media may be produced using any art recognized method. For example, the filter media may be produced by being airlaid, spunbonded, wetlaid, meltblown, electrospun, needle punched, spunlaced, carded, or thermally bonded.

According to one embodiment when the oxidized fiber is used in combination with the synthetic fiber, the oxidized fiber may be blended with the synthetic fiber and the synthetic fiber acts as a binder for the oxidized fiber. The oxidized cellulose kraft fiber can be blended with the synthetic fiber and wet laid to produce a substrate product. Any art recognized method for forming a nonwoven from a synthetic material and a natural material may be used to produce the filter media described herein.

The filter media as described herein may be subject to any suitable post production treatment, including, but not limited to, embossing calendaring, corona-discharge, needling, co-mingling of certain fibers to generate electret properties or triobelectric potential. The filter media may be treated with any suitable finishing treatment, including but not limited to, aqueous fluid repellents, anti-microbial treatments, flame retardants or micro-encapsulants.

The filters and filter media as described herein may incorporate other fibers, materials or particles as are understood in the art for use in filter media. For example, water filters are often made from non-woven fibrous materials, but they can often have other materials, for example, activated carbon dispersed in the fibrous web. The oxidized kraft cellulose filter media as described herein may be used with art recognized additives.

The filter media as described herein may be used in a variety of filter applications including but not limited to ventilation systems, including industrial air handlers, air sampling, clean rooms, respiratory protection, and industrial processes. More specifically, the filter media as described herein may be used in a variety of filter formats, including, but not limited to panel filters, pad filters, HEPA filters, clean room filters, fan filters, fan coil units, automobile filters, spray booth filters, automotive assembly filters, bag filters, extended surface rigid filters, cartridge filters, blanket filters, prefilters, as turbine intake systems, box frame filters, beer filters, vacuum cleaner bags. The filter media as described herein is preferably used in the production of automobile intake and air filters and HVAC filters. According to one embodiment, when the filter media comprises only oxidized kraft cellulose fiber, the fiter or prefilter is compostable and/or recyclablable.

It should be noted that the methods and products described herein should not be limited to the examples provided. Rather, the examples are only representative in nature.

### EXAMPLE

Oxidized cellulose kraft fiber was evaluated for anti-microbial activity using the method JIS L 1902:2008 (ISO 20743). This evaluation method was used since TAPPI provides no method for antibacterial testing and this method is the basis for the Japanese personal hygiene industry labeling. Non-oxidized kraft cellulose was compared to two oxidized kraft cellulose materials produced according to the methods referenced herein to ascertain the efficacy of the oxidation treatment to reduce or prevent bacterial and viral proliferation in filtration media. The fiber was tested for E-coli, Staphylococus aureus, Salmonella enterica-pulloram, listeria mono-cytogenes, rhinovirus and Influenza.

The test sample was prepared at 0.4 grams of material. It was placed into a container and steam sterilized and dried. The sample was inoculated with 0.2 ml of serum containing the bacteria or virus to be tested. The sample was allowed to incubate at 37° C. for the time specified in Table 2 below. After incubation the sample was washed with 20 ml of saline. The spores were counted and then reported as described in Table 1.

Reported below is the percent reduction in bacterial growth versus the control fiber.

TABLE 2

| | | | | Percent |
|---|---|---|---|---|
| | | | | Inhibition as |
| | | Incubation | | compared |
| Fiber | Bacteria | Time | | to control |
| Control | Salmonella | 7 | hours | |
| Sample 1 | Salmaonella | 7 | hours | 95.10% |
| Sample 2 | Salmonella | 7 | hours | 97.66% |
| Control | E coli | 7 | hours | |
| Sample 1 | E coli | 7 | hours | 99.97% |
| Sample 2 | E coli | 7 | hours | 99.94% |
| Control | Staph | 7 | hours | |
| Sample 1 | Staph | 7 | hours | 99.91% |
| Sample 2 | Staph | 7 | hours | 99.48% |
| Control | Listeria | 72 | hours | |
| Sample 1 | Listeria | 72 | hours | 99.91% |
| Sample 2 | Listeria | 72 | hours | 99.78% |

The same samples were challenged with Rhinovirus and Influenza. Sample 1 killed 99.2% of Rhnovirus and 99.95% of influenza while sample 2 killed 93% of Rhinovirus but had no affect on Influenza.

Although specific embodiments have been illustrated and described herein, it should be appreciated that any arrangement configured to achieve the same purpose may be substituted for the specific embodiments shown. This disclosure is intended to cover any and all adaptations or variations of various embodiments. Combinations of the above embodiments, and other embodiments not described herein, will be apparent to those of skill in the art upon reviewing the above description.

We claim:

1. A fluid filter media comprising,
a substrate comprising randomly arranged fibers wherein the fibers comprise oxidized kraft cellulose fiber.

2. The filter media of claim 1, wherein the substrate exhibits antimicrobial properties.

3. The filter media of claim 1, wherein the fibers further comprise synthetic fibers.

4. The filter media of claim 3, wherein the synthetic fibers are chosen from one or more of fiberglass fibers, polypropylene fibers and polyester fibers.

5. An air filter comprising,
a frame enclosing a filter media,
wherein the filter media comprises a mat of randomly arranged fibers wherein the fibers comprise synthetic fiber and oxidized kraft cellulose fiber.

6. The air filter of claim 5, wherein the filter media exhibits antimicrobial properties.

7. The air filter of claim 6, wherein the air filter is an HVAC filter and the synthetic fiber is fiberglass.

8. The air filter of claim 7, wherein the filter media is pleated.

9. The air filter of claim 5, wherein the filter is a HEPA filter.

10. The air filter of claim 9, wherein the HEPA filter comprises a high density pack of filter media.

11. A liquid filter comprising,
a substrate of randomly arranged fibers wherein the fibers comprise oxidized kraft cellulose fibers.

12. The liquid filter of claim 11, wherein the filter media exhibits antimicrobial properties.

13. The liquid filter of claim 11, wherein the fibers further comprise synthetic fibers.

14. The liquid filter of claim 11, wherein the filter media is pleated.

15. The liquid filter of claim 11, wherein the liquid to be filtered is water.

16. A method of filtering fluid comprising,
providing a filter media that comprises randomly arranged fibers comprised of synthetic fiber and oxidized kraft cellulose fiber;
passing fluid to be filtered through a filter;
collecting contaminants from the fluid stream in the filter media.

17. The method of claim 16, wherein the fluid is air or water.

18. The method of claim 16, wherein the filter media exhibits anti-microbial properties.

19. The method of claim 16, wherein the filter is a water purification filter.

20. The method of claim 16, wherein the filter is an HVAC filter.
